(19) United States
(12) Patent Application Publication
(10) Pub. No.: US 2014/0301189 A1
(43) Pub. Date: Oct. 9, 2014

(54) INFORMATION PROVIDING APPARATUS AND WIRELESS COMMUNICATION APPARATUS

(71) Applicant: KABUSHIKI KAISHA TOSHIBA, TOKYO (JP)

(72) Inventors: Seiichiro Horikawa, Yokohama-shi (JP); Takayoshi Ito, Yokohama-shi (JP); Koji Akita, Yokohama-shi (JP)

(73) Assignee: KABUSHIKI KAISHA TOSHIBA, TOKYO (JP)

(21) Appl. No.: 14/199,709

(22) Filed: Mar. 6, 2014

(30) Foreign Application Priority Data
Apr. 3, 2013 (JP) 2013-077915

(51) Int. Cl. H04W 28/02

(52) U.S. Cl. CPC H04W 28/0289
USPC 370/230

(57) ABSTRACT

An information providing apparatus has a first communication part to perform communication with a communication apparatus, a main-information storage to store main information to be transmitted to the communication apparatus via the first communication part, a sub-information acquisition part to acquire sub-information reproducible separately from the main information and related to the main information, and a communication controller to control so that the main information and the corresponding sub-information is transmitted from the first communication part to the communication apparatus, when a transmission request for the main information is acquired from the communication apparatus.

### CROSS-REFERENCE TO RELATED APPLICATIONS

This application is based upon and claims the benefit of priority from Japanese Patent Application No. 2013-77915 filed on Apr. 3, 2013, the entire contents of which are incorporated herein by reference.

### FIELD

Embodiments of the present invention rerate to an information providing apparatus and a wireless communication apparatus for transmitting main information by wireless communication.

### BACKGROUND

With improvement of the performance of portable terminals such as a portable phone, a smart phone, etc., it has actually become possible to browse information related to a moving picture on web while reproducing the moving picture at a TV by transmitting streaming data to the TV from a portable terminal.

However, it is a heavy burden on portable terminals to perform streaming-data transmission and web browsing at the same time. There are some cases where it is impossible to keep a necessary transfer speed, thereby causing frame dropping or preventing smooth web browsing. Moreover, since portable phones have limited battery capacity, the battery power life may become short if streaming-data transmission and web browsing are performed at the same time, thus usability becomes worse.

### BRIEF DESCRIPTION OF THE DRAWINGS

FIG. 1 is a block diagram schematically showing the configuration of a wireless communication system 1 provided with an information distribution server 100 and a portable terminal 300 according to a first embodiment;

FIG. 2 is a block diagram showing an example of the internal configuration of the data distribution server 100;

FIG. 3 is a flowchart showing an operation of the wireless communication system 1 according to the first embodiment;

FIG. 4 is a block diagram showing an internal configuration of a data distribution server 100 according to a second embodiment;

FIG. 5 is a flowchart showing an operation of a wireless communication system 1 according to the second embodiment;

FIG. 6 is a view showing an example of a table managed by a sub-data manager 130;

FIG. 7 is a view showing an example of a table in which main data, main-data identifiers, web sites, and the number of web-browsing times are associated with one another;

FIG. 8 is a view showing an example of a table in which main data, main-data identifiers, web site names, and web browsing dates are associated with one another;

FIG. 9 is a view showing an example of a table in which main data and sub-data are associated with each other;

FIG. 10 is a block diagram showing an example of providing a second communication part 150 in a data distribution server 100, in addition to a first communication part 110;

FIG. 11 is a view showing an example of a table in which each portable terminal 300 that performs communication with the data distribution server 100 and acquisition information of a communication history are associated with each other;

FIG. 12 is a block diagram of an internal configuration of a portable terminal 300 according to the second embodiment;

FIG. 13 is a view showing an example of a communication history stored in a communication history storage 340;

FIG. 14 is a view showing another example of a communication history stored in the communication history storage 340;

FIG. 15 shows an example of storing a table in which, instead of the number of browsing times, a browsing date is related, in the communication history storage 340;

FIG. 16 is a block diagram of a portable terminal 300 according to one modification of FIG. 12;

FIG. 17 is a view showing an example of transmitting a communication history to a data distribution server 100 via an external network connected to a second wireless part 320;

FIG. 18 is a view showing an example of displaying main data and also the corresponding sub-data on a display part of a portable terminal 300; and

FIG. 19 is a block diagram showing an internal configuration of a data distribution server 100 according to a third embodiment.

### DETAILED DESCRIPTION

An information providing apparatus has a first communication part to perform communication with a communication apparatus, a main-information storage to store main information to be transmitted to the communication apparatus via the first communication part, a sub-information acquisition part to acquire sub-information reproducible separately from the main information and related to the main information, and a communication controller to control so that the main information and the corresponding sub-information is transmitted from the first communication part to the communication apparatus, when a transmission request for the main information is acquired from the communication apparatus.

Embodiments will now be explained with reference to the accompanying drawings.

### First Embodiment

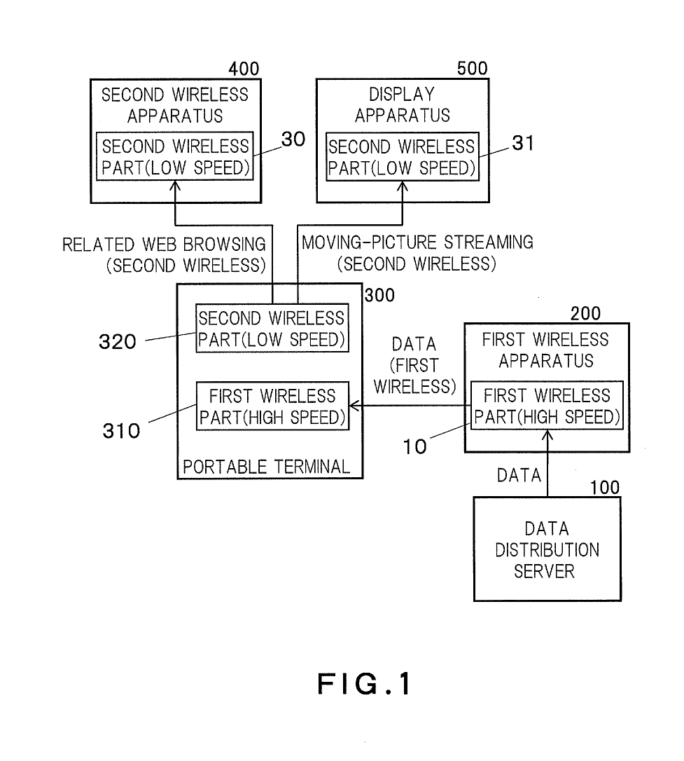

FIG. 1 is a block diagram schematically showing the configuration of a wireless communication system 1 provided with an information distribution server (an information providing apparatus) 100 and a portable terminal 300 according to a first embodiment. The wireless communication system 1 of FIG. 1 is provided with an information distribution server (a data distribution server) 100, a first wireless apparatus 200, a portable terminal 300, a second wireless apparatus 400, and a display apparatus 500.

The information distribution server 100 transmits main information to the portable terminal 300 via the first wireless apparatus 200 by high-speed wireless communication. The main information is, for example, moving picture content such as a movie, music data, etc. and includes streaming data that is reproducible while being transmitted. Hereinbelow, the main information is referred to as main data as a general term and the information distribution server 100 is referred to as a data distribution server 100.

The first wireless apparatus 200 is an apparatus having a first wireless part 10 capable of high-speed wireless communication that is, for example, a home server installed in each home, a kiosk terminal installed in a shop of an information distributor, etc. The first wireless apparatus 200 and the data distribution server 100 may be combined into one apparatus. That is, the data distribution server 100 may have the function of the first wireless apparatus 200.

As described later, the portable terminal 300 has at least two wireless parts (a first wireless part 310 and a second wireless part 320) for performing high-speed wireless communication with the first wireless apparatus 200 by using the first wireless part 310 and low-speed wireless communication with the display apparatus 500 and the second wireless apparatus 400 by using the second wireless part 320. The portable terminal 300 is a smart phone, a mobile phone, etc.

The display apparatus 500 is, for example, a home-use TV, to which a variety of electronic devices having a wireless communication function and a display function are applicable. Instead of the display apparatus 500, an audio output apparatus having a speaker (for example, an audio component) may be provided for audio streaming reproduction. The second wireless apparatus 400 is, for example, a wireless station connectable to the Internet.

The second wireless apparatus 400 and the display apparatus 500 have second wireless parts 30 and 31, respectively, for low-speed wireless communication with a second wireless part 320 in the portable terminal 300.

In this embodiment, main data acquired by the portable terminal 300 from the data distribution server 100 via the first wireless apparatus 200 is transmitted to the display apparatus 500 to perform streaming reproduction and, while the main data is being reproduced, sub-information related to the main data is displayed on a display part in the mobile terminal 300, with no access to the second wireless apparatus 400. Accordingly, during the streaming reproduction, sub-information can be displayed on a display part of the portable terminal 300, with no access from the second wireless part 320 to the second wireless apparatus 400 to acquire the sub-information. Accordingly, according to this embodiment, frequency of access from the portable terminal 300 to the second wireless apparatus 400 by using the second wireless part 320 can be reduced so that the second wireless part 320 can be used for streaming reproduction. Therefore, streaming reproduction can be performed smoothly and power consumption of the portable terminal 300 can be reduced.

The sub-information is information that is reproducible separately from main data, that does not include information such as header information which itself is not reproducible. The sub-information is, for example, information that includes a web site related to main data (for example, an HTML file of a web site, a moving picture related to main data, etc.), that is not a URL address indicating the location of a web site nor link information. Hereinbelow, the sub-information is referred to as sub-data as a general term.

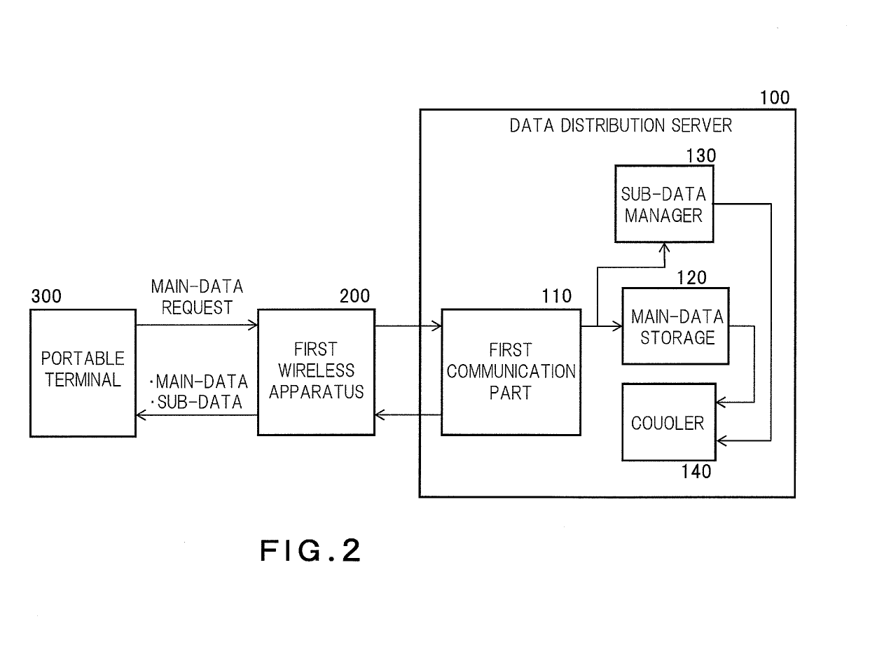

FIG. 2 is a block diagram showing an example of the internal configuration of the data distribution server 100. The data distribution server 100 of FIG. 2 has a first communication part 110, a main-data storage 120, a sub-data manager 130, and a coupler 140.

The main-data storage 120 stores main data. The sub-data manager 130 acquires and stores sub-data related to the main data. The storage for storing sub-data may be provided separately from the sub-data manager 130.

The coupler 140 couples main data and the corresponding sub-data to each other to create coupled information. The coupler 140 may not necessarily physically couple main data and sub-data but may associate main data with sub-data. The coupler 140 controls transmission of main data for which a transmission request has been sent from the portable terminal 300 and the corresponding sub-data to a communication apparatus via the first communication part 110. As described above, the coupler 140 functions as a communication controller.

The first communication part 110 performs high-speed communication with the first wireless apparatus 200. The communication between the first communication part 110 and the first wireless apparatus 200 may be wired or wireless.

The sub-data manager 130 acquires sub-data related to main data by, for example, accessing a specific web site. The sub-data manager 130 acquires, by some means, sub-data corresponding to each main data in accordance with information such as a web site from which the sub-data is accessible, for each main data.

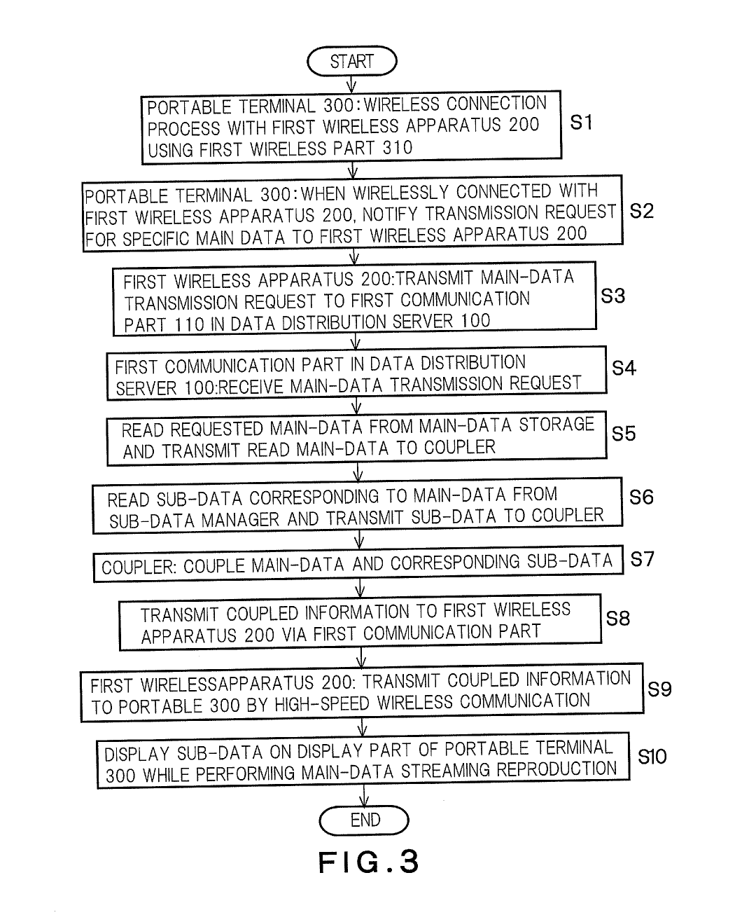

FIG. 3 is a flowchart showing an operation of the wireless communication system 1 according to the first embodiment. Firstly, the portable terminal 300 performs a wireless connection process with the first wireless apparatus 200 by using the first wireless part 310 (Step S1). When wirelessly connected with the first wireless apparatus 200, the portable terminal 300 notifies a transmission request for specific main data to the first wireless apparatus 200 (Step S2). The first wireless apparatus 200 that has received this notification transmits the request to the first communication part 110 in the data distribution server 100 (Step S3).

The first communication part 110 in the data distribution server 100 receives the request (Step S4), reads the requested main data from the main-data storage 120 (Step S5) and also reads sub-data corresponding to the main data from the sub-data manager 130 (Step S6) to transmit the main data and the corresponding sub-data to the coupler 140. The coupler 140 couples the main data and the corresponding sub-data to each other (Step S7) and transmits the coupled information to the first wireless apparatus 200 via the first communication part 110 (Step S8).

The first wireless apparatus 200 transmits the coupled information to the portable terminal 300 by high-speed wireless communication (Step S9). The first wireless part 310 of the portable terminal 300 receives this information and transmits the main data to the display apparatus 500 via the second wireless part 320 to perform streaming reproduction, and during the streaming reproduction, displays the sub-data corresponding to the main data on a display part of the portable terminal 300 according to need (Step S10). Conventionally, in order to display sub-data, it has been required to access the second wireless apparatus 400 via the second wireless part 320. However, according to this embodiment, sub-data can be displayed on the portable terminal 300, thus it is unnecessary to access the second wireless apparatus 400.

As described above, according to the first embodiment, while the portable terminal 300 is transmitting main data to the display apparatus 500 by streaming transmission, in order to easily reproduce sub-data related to the main data, the data distribution server 100 transmits, in advance, main data and the corresponding sub-data to the portable terminal 300. Accordingly, while transmitting main data to the display apparatus 500, the portable terminal 300 is not required to access the second wireless apparatus 400 via the second wireless part 320 to acquire sub-data. Therefore, the second wireless part 320 can be used for main-data streaming reproduction so that the portable terminal 300 can stably transmit main data to the display apparatus 500.

### Second Embodiment

In a second embodiment which will be described below, a data distribution server 100 acquires sub-data based on a communication history transmitted from a portable terminal 300 different from the portable terminal 300 that has requested main data.

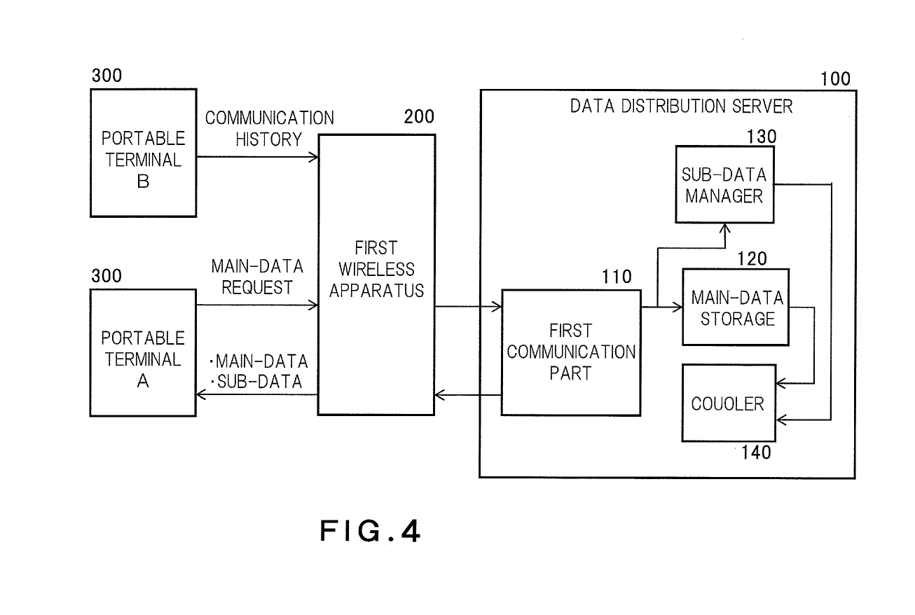

FIG. 4 is a block diagram showing an internal configuration of a data distribution server 100 according to the second embodiment. The data distribution server 100 of FIG. 4 is provided with, like FIG. 2, a main-data storage 120, a sub-data manager 130, a coupler 140, and a first communication part 110.

In addition to communication with a portable terminal A that requests main-data transmission, the first communication part 110 performs a process of receiving a communication history transmitted from another portable terminal B.

The data distribution server 100 of FIG. 4 performs a process of transmitting sub-data corresponding to main data to the portable terminal A in accordance with a transmission request for specific main data from the portable terminal A and a process of acquiring sub-data based on a communication history transmitted from the other portable terminal B, independently from each other. The former process is the same as that of the first embodiment, hence its explanation being omitted, and an operation of acquiring sub-data will be explained hereinbelow.

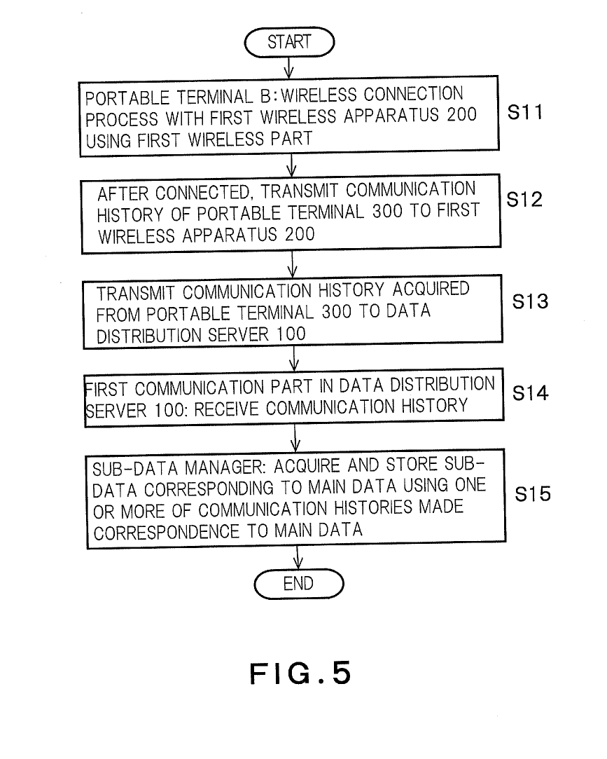

FIG. 5 is a flowchart showing an operation of a wireless communication system 1 according to the second embodiment. Firstly, the portable terminal B that transmits a communication history performs a wireless connection process with a first wireless apparatus 200 by using a first wireless part 310 (Step S11), and after being connected, transmits a communication history of a portable terminal 300 to the first wireless apparatus 200 (Step S12). The communication history is a history of the portable terminal 300 that browsed sub-data related to main data, while viewing and/or listening to the main data. It is a history of, for example, browsing a web site that provides information related to main data. Or the communication history may be a URL addresses itself at the time of browsing or information that is a part of the URL address. For example, when a URL address is expressed as http://AAA/BBB/CCC/DDD/EEE, http://AAA/BBB/CCC/DDD or http://AAA/BBB/CCC that is an address in an upper layer may be used as a communication history.

As a method for associating a communication history with main data, for example, a communication history may be stored in association with a main-data identifier.

It is a precondition for the portable terminal 300 according to this embodiment that the portable terminal 300 stores the above-described communication history in association with main data. A specific internal configuration of the portable terminal 300 will be described later.

The first wireless apparatus 200 transmits the communication history acquired from the portable terminal 300 to the data distribution server 100 (Step S13). When the first communication part 110 in the data distribution server 100 has received the communication history (Step S14), the first communication part 110 transmits the received communication history to the sub-data manager 130. The sub-data manager 130 acquires and stores sub-data corresponding to main data by using one or a plurality of communication histories in association with the main data (Step S15).

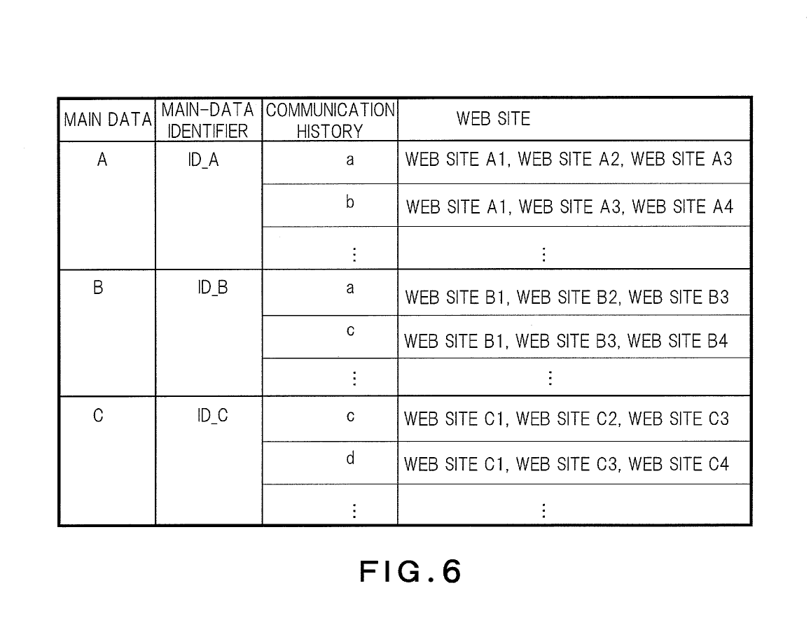

FIG. 6 is a view showing an example of a table managed by the sub-data manager 130. In this table, a correspondence relationship among main data, main-data identifiers, communication histories, and information of web sites that are sub-data is registered. When a new communication history is sent from the portable terminal 300, the sub-data manager 130 registers a correspondence relationship between the new communication history and the main data and the like in the table of FIG. 6. The table of FIG. 6 may be provided in the sub-data manager 130 or, separated from the sub-data manager 130, a storage for storing the table of FIG. 6 may be provided.

FIG. 6 shows an example of web browsing at web sites shown in communication histories a, b, . . . during streaming reproduction of main data A identified with a main-data identifier ID_A, web browsing at web sites shown in communication histories a, c, . . . during streaming reproduction of main data B identified with a main-data identifier ID_B, and web browsing at web sites shown in communication histories c, d, . . . during streaming reproduction of main data C identified with a main-data identifier ID_C.

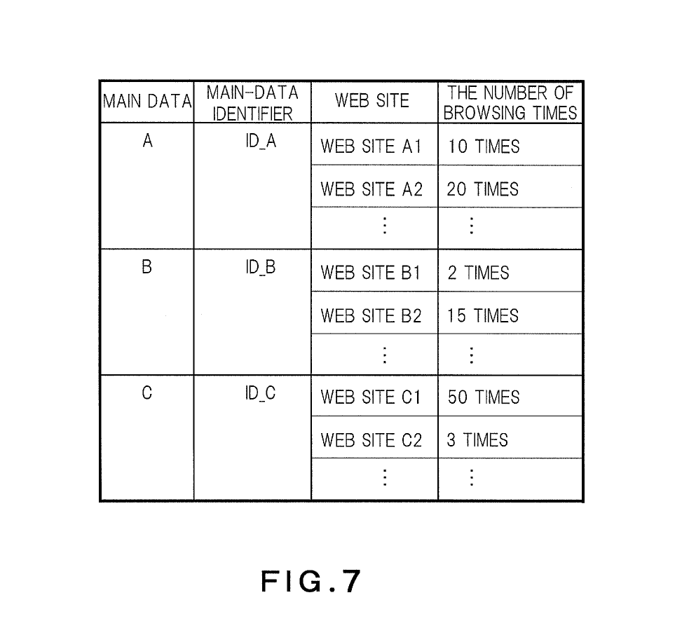

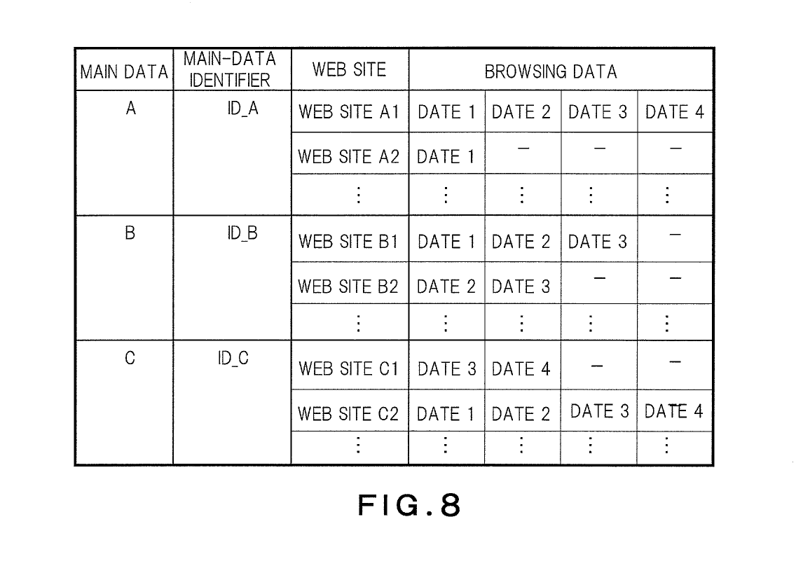

The table of FIG. 6 is merely one example. A variety of information that expresses a correspondence relationship between main data and sub-data are considered. For example, FIG. 7 is a view showing an example of a table in which main data, main-data identifiers, web sites, and the number of web-browsing times are associated with one another. Moreover, FIG. 8 is a view showing an example of a table in which main data, main-data identifiers, web site names, and web browsing dates are associated with one another.

In the table of FIGS. 6 to 8, information of communication histories, sent from a plurality of portable terminals, that have been collected and classified are registered. Among the information on the communication histories registered in these tables, old information that have been registered over a specific period of time may be automatically removed. Accordingly, sub-data can be acquired based on newer communication history.

Moreover, users who view and/or listen to the same main data are expected to browse the same kind of web sites. Therefore, for example, web sites that are browsed frequently may be extracted from communication histories of an unspecified large number of portable devices 300 to create sub-data based on the extracted web sites. In this way, the reliability of sub-data becomes higher.

Furthermore, for example, a communication history of each user may be analyzed to create or acquire sub-data for each user based on each user's preference. The communication history to be used may be communication histories acquired for a specific period only or all past communication histories. In addition to communication histories, the attributes (an age bracket, sex, etc.) of users of the portable terminal 300 may be used to create or acquire sub-data. The sub-data creation or acquisition process may be performed when a communication history that satisfies a specific requirement is acquired or whenever a communication history is acquired.

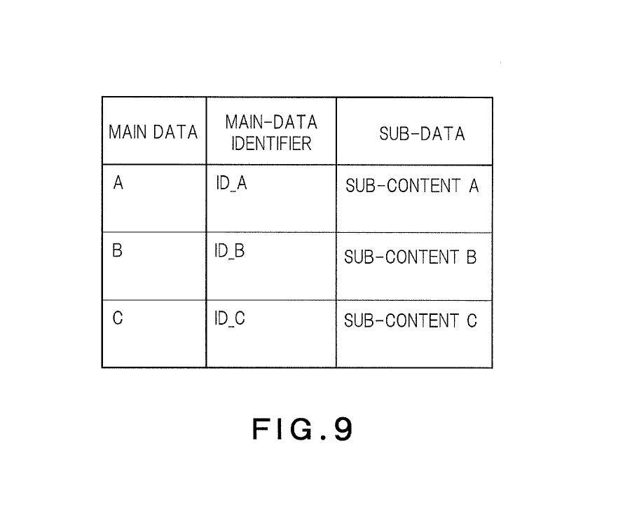

The sub-data manager 130 may create a table, such as shown in FIG. 9, in which main data and sub-data are associated with each other based on a table such as shown in FIGS. 6 to 8. In the table of FIG. 9, main data, main-data identifiers and sub-data associated with one another are registered. By providing a table such as shown in FIG. 9, sub-data that corresponds to main data for which a transmission request has been sent from a portable terminal 300 can be quickly acquired and coupled to the main data, and the coupled information can be transmitted quickly to the portable terminal 300 that has sent the transmission request.

In FIG. 4, the first communication part 110 in the data distribution server 100 receives a main-data transmission request from a portable terminal 300 via the wireless apparatus 200, and transmits main data and sub-data to this portable terminal 300, and, in addition, acquires a communication history from another portable terminal 300. Different from this, a communication part for acquiring a communication history may be provided separately from the communication part for transmitting and/or receiving a main-data transmission request and main data.

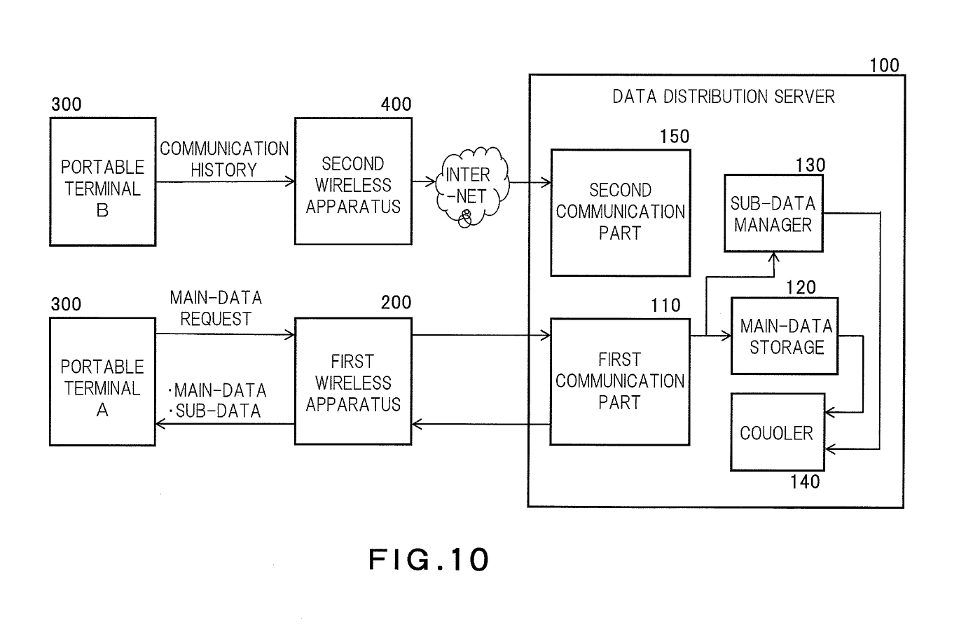

FIG. 10 is a block diagram showing an example of providing a second communication part 150 in the data distribution server 100, in addition to the first communication part 110. The first communication part 110 has a high-speed communication function of receiving a main-data transmission request transmitted from the portable terminal A via the first wireless apparatus 200 and transmits main data and sub-data at high speed to this portable terminal A via the first wireless apparatus 200. Different from this, the second communication part 150 receives a communication history transmitted from the portable terminal B to the second wireless apparatus 400, at a communication speed lower than that of the first communication part 110.

The communication between the first wireless apparatus 200 and the first communication part 110 may be wired or wireless. Likewise, the communication between the second wireless apparatus 400 and the second communication part 150 may be wired or wireless. The portable terminal A performs wireless communication with the first wireless apparatus 200, the wireless-communication range of which may be narrower than a wireless-communication range of the portable terminal B for communication with the second wireless apparatus 400. In this way, communication histories from many portable terminals B located in as large of an area as possible can be acquired.

In order to create in advance or acquire sub-data corresponding to main data, the data distribution server 100 is required to acquire communication histories of as many of portable devices 300 as possible and to know, in advance, sub-data in association with the main data. In order to assist each portable terminal 300 to transmit its own communication history to the data distribution server 100, the data distribution server 100 may provide sub-data corresponding to main data to only the portable devices 300 that have transmitted communication histories to the data distribution server 100. In this way, each portable terminal 300 cannot receive sub-data unless it transmits its own communication history to the data distribution server 100 in advance. Therefore, the number of portable devices 300 that transmit communication histories to the data distribution server 100 can be increased and the sub-data reliability becomes higher accordingly.

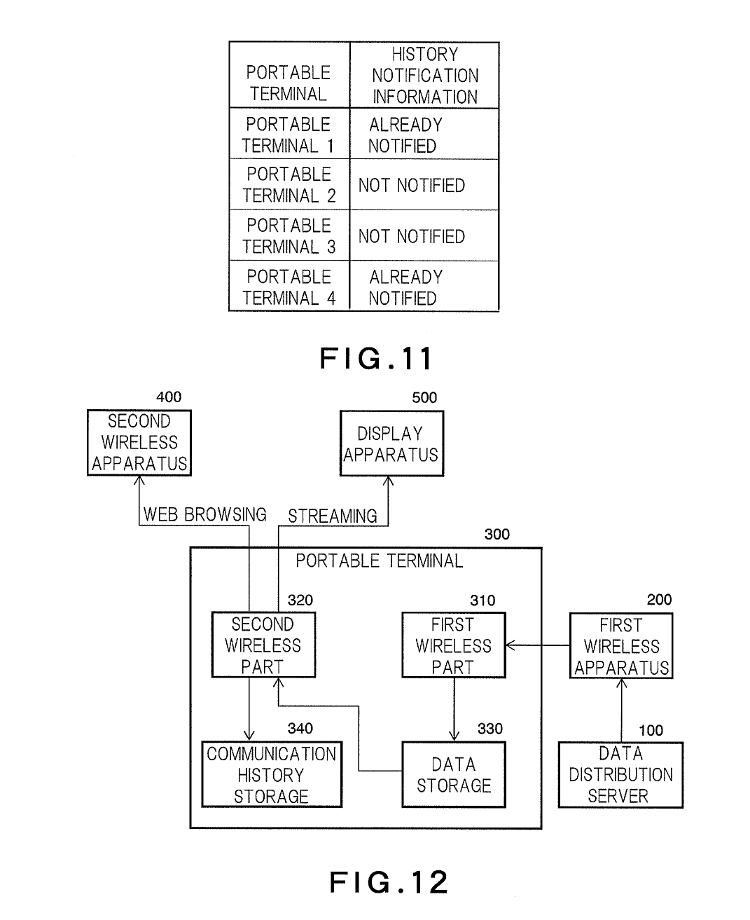

In order to identify whether or not a portable terminal 300 transmitted a communication history in the part, a table such as shown in FIG. 11 may be provided in the data distribution server 100. In this table, portable devices 300 that communicate with the data distribution server 100 and communication-history acquisition information associated with each other are registered. With this kind of table, when receiving a main-data transmission request from a portable terminal 300, the data distribution server 100 looks up this table to identify whether or not the portable terminal 300, that has transmitted the main-data transmission request, transmitted a communication history in the part. In this way, the data distribution server 100 can transmit sub-data to only the portable devices 300 that transmitted communication histories in the part.

FIG. 12 is a block diagram of an internal configuration of the portable terminal 300 according to the second embodiment. This portable terminal 300 can also be used as the portable terminal 300 of the first embodiment. The portable terminal 300 of FIG. 12 is provided with a first wireless part 310, a second wireless part 320, an information storage (a data storage) 330, and a communication history storage 340.

The first wireless part 310 performs wireless communication with the first wireless apparatus 200 at a first communication speed. The second wireless part 320 performs wireless communication with a display apparatus 500 and a second wireless apparatus 400 at a second communication speed lower than the first communication speed.

The second wireless part 320 transmits main data to the display apparatus 500 by streaming transmission.

The display apparatus 500 reproduces received main data one after another by streaming reproduction. As described above, instead of the display apparatus 500, an audio output apparatus may be provided.

The second wireless part 320 can perform wireless communication with the second wireless apparatus 400 while performing main-data streaming transmission to the display apparatus 500. Accordingly, a user of the portable terminal 300 can acquire sub-data related to main data from the second wireless apparatus 400 while performing main-data streaming reproduction. The sub-data to be acquired is, for example, web browsing information.

Nevertheless, the portable terminal 300 according to this embodiment acquires sub-data corresponding to main data from a data distribution server 100 as much as possible in order to reduce the amount of sub-data acquired from the second wireless apparatus 400 as much as possible.

The information storage 330 stores main data acquired by the first wireless part 310. The stored main data is transmitted to the display apparatus 500 via the second wireless part 320 and reproduced by streaming reproduction. The information storage 330 can store sub-data in addition to main data and may store other information. Hereinbelow, the information storage 330 is referred to as a data storage 330.

The communication history storage 340 associates a communication history between the second wireless part 320 and the second wireless apparatus 400 performed while the second wireless part 320 is transmitting main data to the display apparatus 500 by streaming transmission, with the main data, and then stores the main data and the corresponding communication history. As described above, the communication history may be a history of web browsing or at least a part of a URL address at which web browsing is performed. Moreover, the communication history may be stored in association with main data, a main data identifier, a browsing date, the number of browsing times, etc.

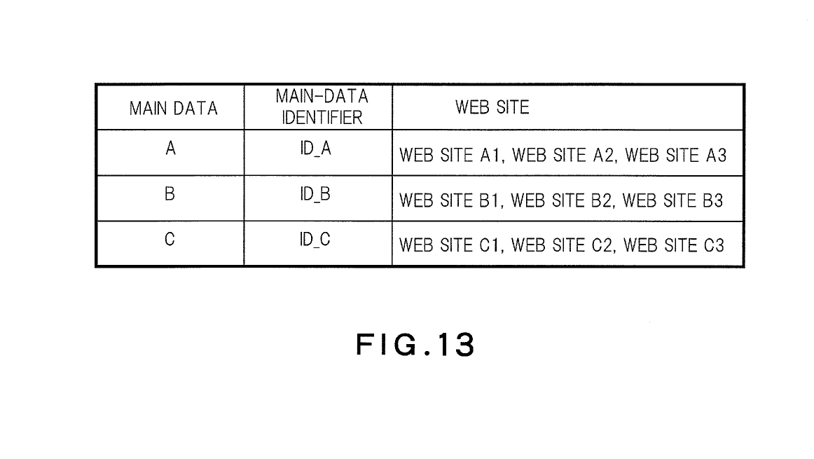

FIG. 13 is a view showing an example of a communication history stored in the communication history storage 340. FIG. 13 shows an example of storing a table of main data, main-data identifiers and browsed web sites associated with one another, in the communication history storage 340. In the table of FIG. 13, a communication history of a portable terminal 300 itself only is registered.

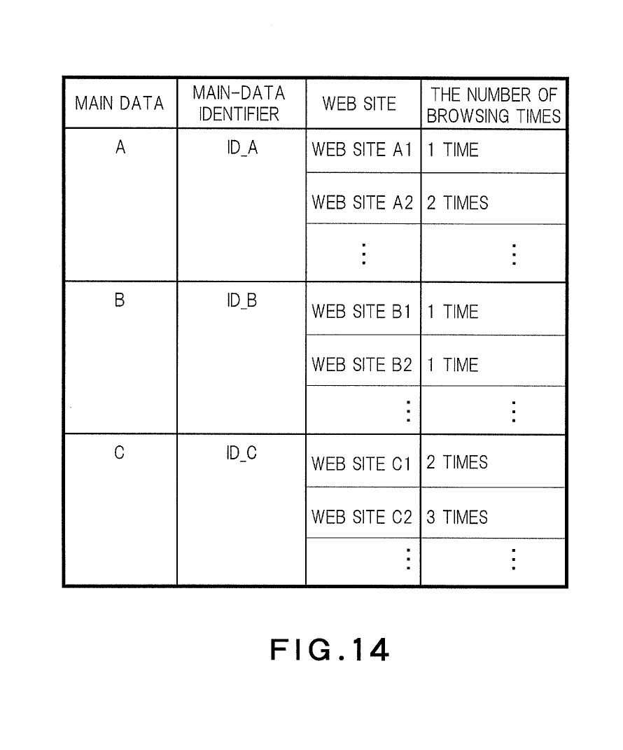

FIG. 14 is a view showing another example of a communication history stored in the communication history storage 340. FIG. 14 shows an example of storing a table in which, in addition to the three items of FIG. 13, the number of browsing times is related, in the communication history storage 340.

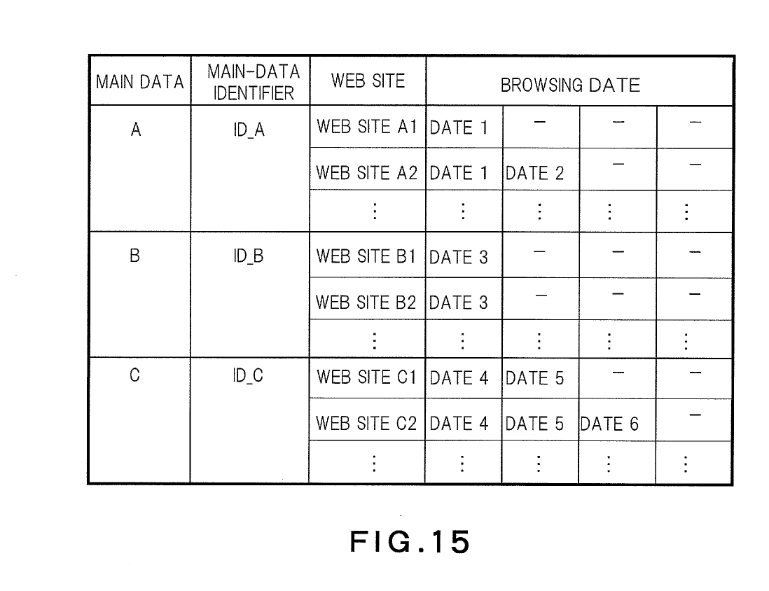

FIG. 15 shows an example of storing a table that in which, instead of the number of browsing times, a browsing date is related, in the communication history storage 340.

As described above, content actually included in the communication history stored in the communication history storage 30 is not limited to one. However, even if a variety of kinds of communication histories are stored in the communication history storage 300, it is in common that only the communication history of each portable device 330 is stored.

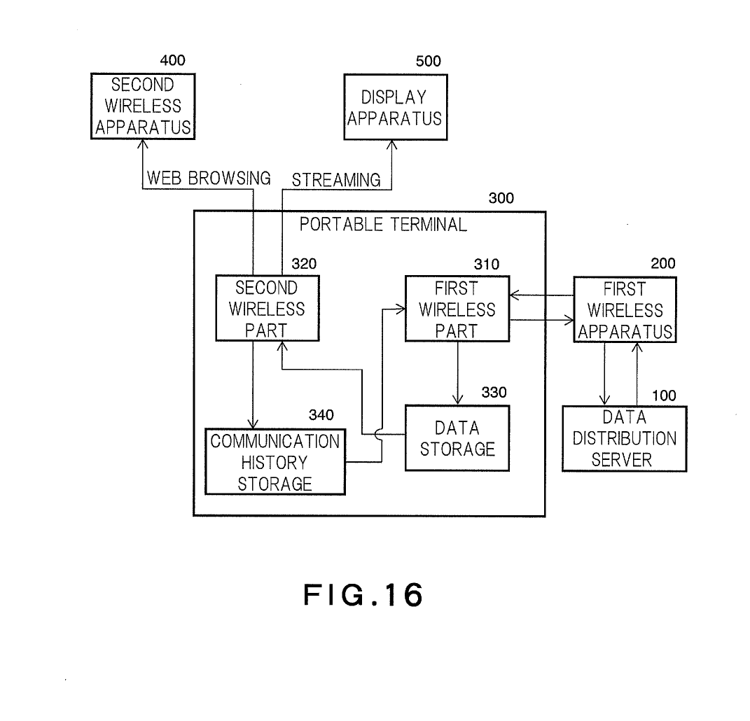

The block diagram of the portable terminal 300 in FIG. 12 does not show how a communication history stored in the communication history storage 300 is transmitted to the data distribution server 100. FIG. 16 shows one example which indicates this mechanism. FIG. 16 is a block diagram of a portable terminal 300 according to one modification of FIG. 12. FIG. 16 shows one example in which the portable terminal 300 transmits a communication history stored in a communication history storage 300 to a first wireless apparatus 200 via a first wireless part 310 and then the first wireless apparatus 200 transmits the communication history to a data distribution server 100.

When the data distribution server 100 or the first wireless apparatus 200 is, for example, a kiosk terminal installed in a shop of an information distributor, a communication history may be transmitted from a user's portable terminal 300 to the kiosk terminal when the user visits the shop. Or when the data distribution server 100 or the first wireless apparatus 200 is a home server installed in each home, a communication history may be transmitted to the home server, for example, at a time of distributing no main-data streaming to a display apparatus 500. The time of distributing no main-data streaming to the display apparatus 500 may, for example, be the streaming-transmission completion time. Or a communication history may be automatically transmitted to the first wireless apparatus 200 during the night in which a user does not use the portable terminal 300.

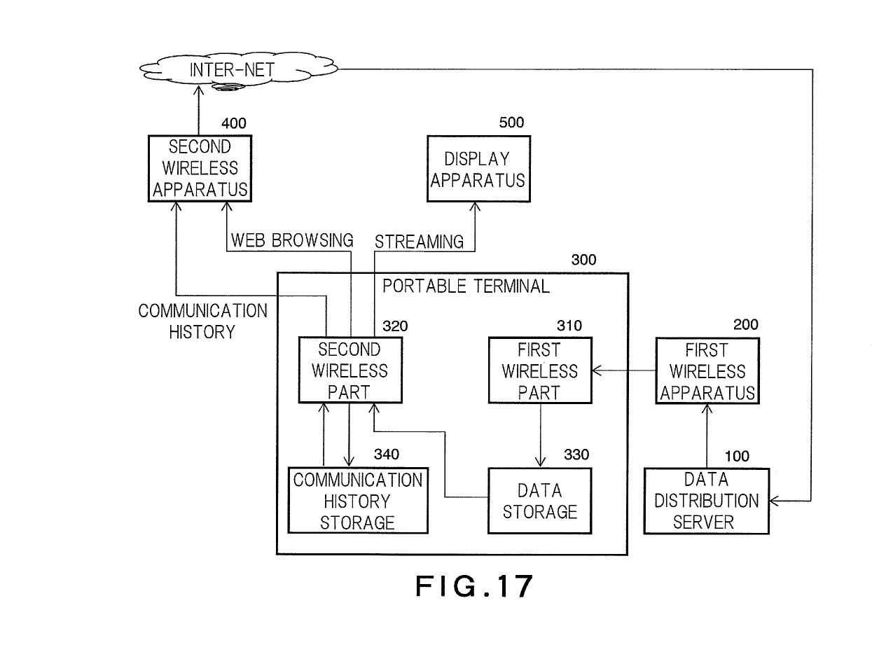

As shown in FIG. 17, a communication history may be transmitted to a data distribution server 100 via an external network connected to a second wireless part 320. The timing at which a communication history is transmitted to the data distribution server 100 may be the time after the completion of streaming transmission to the display apparatus 500.

The period of storing a communication history in the communication history storage 340 may be the entire period during which main data is transmitted to the display apparatus 500 and then the display apparatus 500 performs streaming reproduction or a part of this period (for example, a period of time from the start of main-data transmission up to a specific time). By setting the storing period to the period of time up to the specific time, the storage of a communication history can be finished before the reproduction of an important conclusion (a climax) part in main-data streaming reproduction. The reason why a communication history for an important conclusion (a climax) part is not stored is that, if a user can grasp the conclusion of main information through sub-data, the user may not enjoy the viewing of and/or listening to the main information to the end. In order to correctly manage the period of storing a communication history in the communication history storage 340, for example, dedicated application software (hereinafter, dedicated application) may be installed in the portable terminal 300, and by using this dedicated application, main-information transmission timing to the display apparatus 500 and the period of storing a communication history in the communication history storage 340 may be managed.

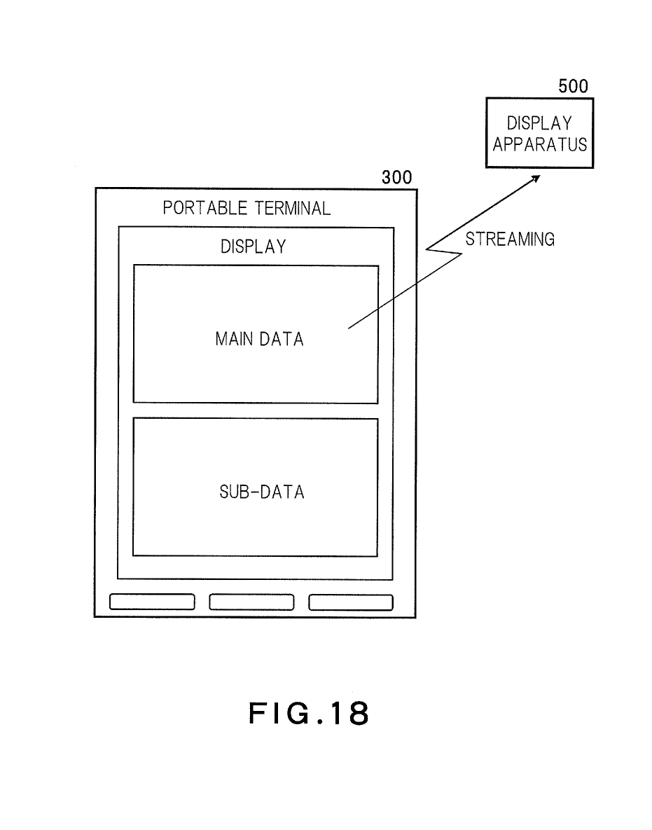

The data storage 330 of FIG. 16 may store not only main data sent from the data distribution server 100 but also sub-data. By storing main data and sub-data in association with each other in the data storage 330, for example, while main data is being transmitted to the display apparatus 500 and the display apparatus 500 is reproducing the main data by streaming reproduction, sub-data corresponding to the main data can be displayed on a display part of the portable terminal 300. Moreover, using dedicated application, as shown in FIG. 18, main data and also the corresponding sub-data may be displayed on the display part of the portable terminal 300.

A communication history stored in the communication history storage 340 may be discarded after being transmitted to the data distribution server 100. Moreover, a communication history stored in the communication history storage 340 may be automatically discarded after a specific period passes.

Likewise, main data and sub-data stored in the data storage 330 may be automatically discarded after a specific period passes. The main data and sub-data for which a period for viewing and/or listening is predetermined for copyright protection may be automatically discarded after the period passes.

As described above, according to the second embodiment, bases on a communication history transmitted from the portable terminal 300 to a data management server, sub-data corresponding to main data is acquired in the data management server. Therefore, by transmitting main data for which the portable terminal 300 has sent a transmission request and also sub-data corresponding to the main data to the portable terminal 300, the portable terminal 300 can reproduce the sub-data on its own display part or the like while reproducing the main data by streaming reproduction, without web browsing.

Moreover, the portable terminal 300 can transmit its own past communication history of web browsing during streaming reproduction to the data distribution server 100. Thus, the data management server can acquire sub-data most appropriate for main data based on communication histories from an unspecified large number of portable devices 300. Therefore, the necessity of web browsing by the portable terminal 300 during streaming reproduction can further be reduced.

### Third Embodiment

A third embodiment which will be described below is different from the first and second embodiments concerning the method for the data distribution server 100 to acquire sub-data.

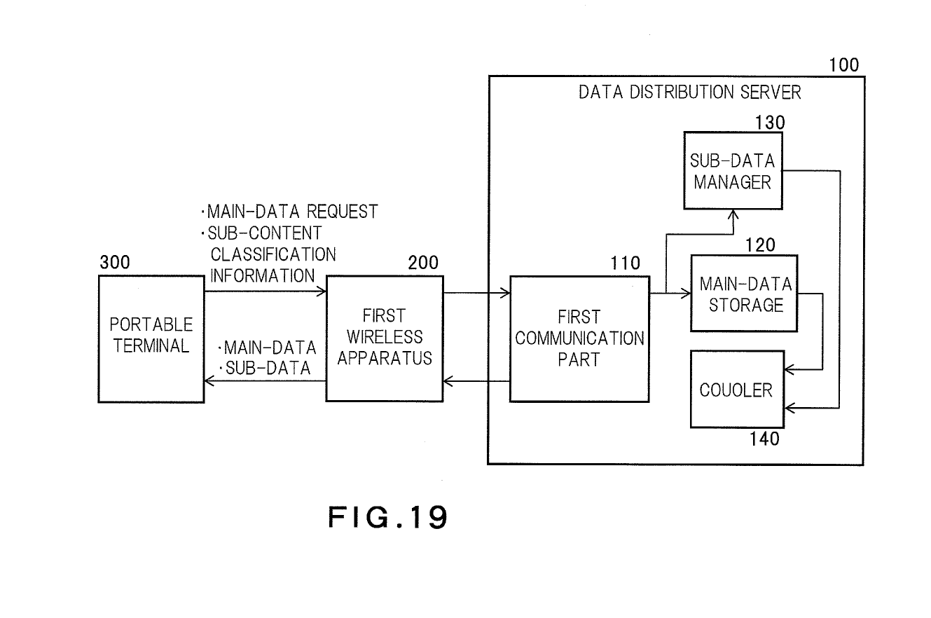

FIG. 19 is a block diagram showing an internal configuration of a data distribution server 100 according to the third embodiment. Like shown in FIG. 2, the data distribution server 100 of FIG. 19 is provided with a main-data storage 120, a sub-data manager 130, a coupler 140 and a first communication part 110. However, the operation of the sub-data manager 130 is different between FIG. 2 and FIG. 19.

The sub-data manager 130 of FIG. 19 receives sub-content classification information in which a user of a portable terminal 300 is interested from the portable terminal 300. The sub-content classification information is, for example, a human correlation diagram of streaming content such as a movie, a drama, etc., cast information, series digest information, etc. Among them, a user of the portable terminal 300 selects information arbitrary and transmits the information to the sub-data manager 130 via the first communication part 110.

Based on sub-content classification information transmitted from a user of the portable terminal 300, the sub-data manager 130 selects the most appropriate sub-data from among a plurality of sub-data prepared in advance and sends the selected sub-data and main data to the coupler 140 by being associated with these data.

Like shown in FIG. 17, the sub-content classification information may be transmitted from the second wireless apparatus 400 to the data distribution server 100, not via the portable terminal 300.

As described above, according to the third embodiment, sub-content classification information of interest for a user of a portable terminal 300 is transmitted to a data management server in advance. Therefore, for each portable terminal 300, the data management server can acquire the most appropriate sub-data based on the transmitted sub-content classification information and transmit the acquired sub-data together with main data. Accordingly, sub-data that belongs to sub-content classification information of interest for a user of a portable terminal 300 can be correctly provided. Therefore, the necessity of web browsing by the portable terminal 300 during main-data, streaming reproduction can be reduced much more than the second embodiment.

The data distribution server 100 of FIG. 19 may acquire the most appropriate sub-data under consideration of the sub-content classification information together with, like the second embodiment, communication histories received from an unspecified large number of portable devices 300.

At least a part of the information providing apparatus and the portable terminal 300 explained in the embodiments may be configured with hardware or software. When it is configured with software, a program that performs at least a part of the functions of the information providing apparatus and the portable terminal 300 may be stored in a storage medium such as a flexible disk and CD-ROM, and then installed in a computer to run thereon. The storage medium may not be limited to a detachable one such as a magnetic disk and an optical disk but may be a standalone type such as a hard disk drive and a memory.

Moreover, a program that achieves the function of at least part of the information providing apparatus and the portable terminal 300 may be distributed via a communication network (including wireless communication) such as the Internet. The program may also be distributed via an online network such as the Internet or a wireless network, or stored in a storage medium and distributed under the condition that the program is encrypted, modulated or compressed.

The embodiment of the present invention is not limited to the respective embodiments described above but includes a variety of modifications conceivable by parsons skilled in the art. The advantages of the present invention are also not limited to those explained above. Accordingly, various addition, changes, and partial omissions may be made without departing from the scope and spirit of the inventions derived from the accompanying claims and their equivalents.

1. An information providing apparatus comprising:
a first communication part configured to perform communication with a communication apparatus;
a main-information storage configured to store main information to be transmitted to the communication apparatus via the first communication part;
a sub-information acquisition part configured to acquire sub-information reproducible separately from the main information and related to the main information; and
a communication controller configured to control so that the main information and the corresponding sub-information is transmitted from the first communication part to the communication apparatus, when a transmission request for the main information is acquired from the communication apparatus.

2. The apparatus of claim 1, wherein the sub-information acquisition part acquires the sub-information based on a communication history of wireless communication related to the main information.

3. The apparatus of claim 2, wherein the communication history is a history of wireless communication related to the main information while the main information is transmitted to the communication apparatus.

4. The apparatus of claim 2, wherein the communication history is a history of wireless communication related to the main information performed by an unspecified large number of communication apparatuses other than the communication apparatus.

5. The apparatus of claim 2 comprising a second communication part configured to acquire the communication history between the second communication part and a second wireless apparatus via the second wireless part, at a communication speed lower than a communication speed of the first communication part to perform communication of the main information and the sub-information with a first wireless apparatus.

6. The apparatus of claim 2 comprising a second communication part configured to acquire the communication history in a communication range larger than a communication range of the communication apparatus to perform wireless communication with the first communication via or not via a relay apparatus.

7. The apparatus of claim 2, wherein the communication controller controls transmission of the main information and the corresponding sub-information via the first communication part to only the communication apparatus having transmitted the communication history.

8. The apparatus of claim 1, wherein the sub-information acquisition part acquires the sub-information corresponding to the main information having been requested to be transmitted, based on specific classification information which is obtained by classifying the sub-information classified and transmitted from the communication apparatus via the first communication part.

9. A wireless communication apparatus comprising:
a first wireless part configured to perform wireless communication;
a second wireless part configured to perform wireless communication at a communication speed lower than the first wireless part;
an information storage configured to store main information received by the first wireless part;
a communication history storage configured to store a communication history of the second wireless part, that is a history during transmission of the main information read from information storage to a communication apparatus via the second wireless part, by associating the communication history with the main information under transmission.

10. The apparatus of claim 9, wherein the first wireless part transmits the communication history stored in the communication-history storage to an information providing apparatus for providing the main information.

11. The apparatus of claim 9, wherein the first wireless part receives the main information and sub-information reproducible separately from the main information and related to the main information from the information providing apparatus; and
the information storage stores the main information and the sub-information by associating the main information with the sub-information.

12. An information providing method comprising:
performing communication with a communication apparatus by a first communication part;
storing main information to be transmitted to the communication apparatus via the first communication part;
acquiring sub-information reproducible separately from the main information and related to the main information; and
controlling so that the main information and the corresponding sub-information is transmitted from the first communication part to the communication apparatus, when a transmission request for the main information is acquired from the communication apparatus.

13. The method of claim 12, wherein the sub-information is acquired based on a communication history of wireless communication related to the main information.

14. The method of claim 13, wherein the communication history is a history of wireless communication related to the main information while the main information is transmitted to the communication apparatus.

15. The method of claim 13, wherein the communication history is a history of wireless communication related to the main information performed by an unspecified large number of communication apparatuses other than the communication apparatus.

16. The method of claim 13 comprising:
acquiring the communication history between the second communication part and a second wireless apparatus via the second wireless part, at a communication speed lower than a communication speed of the first communication part to perform communication of the main information and the sub-information with a first wireless apparatus.

17. The method of claim 13 comprising:
acquiring the communication history in a communication range larger than a communication range of the communication apparatus to perform wireless communication with the first communication via or not via a relay apparatus.

18. The method of claim 13, wherein transmission control of the main information and the corresponding sub-information via the first communication part is performed to only the communication apparatus having transmitted the communication history.

19. The method of claim 12, wherein the sub-information corresponding to the main information having been requested to be transmitted, is acquired based on specific classification information which is obtained by classifying the sub-information classified and transmitted from the communication apparatus via the first communication part.
